(19) United States
(12) Patent Application Publication
(10) Pub. No.: US 2026/0009696 A1
(43) Pub. Date: Jan. 8, 2026

(54) TEST BENCH FOR AT LEAST ONE VEHICLE COMPONENT AND METHOD FOR GENERATING A TRANSLATIONAL LOAD

(71) Applicant: dSPACE GmbH, Paderborn (DE)

(72) Inventors: Marcel PLEISCHL, Paderborn (DE); Benjamin KOERNER, Paderborn (DE)

(73) Assignee: dSPACE GmbH, Paderborn (DE)

(21) Appl. No.: 19/259,307

(22) Filed: Jul. 3, 2025

(30) Foreign Application Priority Data
Jul. 4, 2024 (DE) 102024118967.3

(51) Int. Cl. G01M 13/027; G01M 13/021; G01M 13/025; G01M 17/04

(52) U.S. Cl. CPC G01M 13/027; G01M 13/021; G01M 13/025; G01M 17/04

(57) ABSTRACT

A test bench for at least one vehicle component, wherein the test bench is set up to exert a translational load on the at least one vehicle component in a direction of a component axis. The test bench has a plurality of drives that are set up to generate the load. A test bench control is provided, which is designed to jointly regulate the drives in order to achieve a load on the vehicle component based on a reference variable. A method for generating a translational load is also provided.

This nonprovisional application claims priority under 35 U.S.C. § 119(a) to German Patent Application No. 10 2024 118 967.3, which was filed in Germany on Jul. 4, 2024, and which is herein incorporated by reference.

### BACKGROUND OF THE INVENTION

### Field of the Invention

The application relates to a test bench for at least one vehicle component and to a method for generating a translational load in the direction of a component axis for a vehicle component in a test bench.

### Description of the Background Art

Vehicle components in a vehicle comprise systems used to perform the driving function, such as, e.g., steering systems, brake systems, damper systems, or the like. Vehicle components are designed to absorb and exert a mechanical load. Mechanical loads can comprise, in particular, translational loads, therefore, forces, and/or rotational loads, therefore, torques.

Devices for executing open- and/or closed-loop tasks in vehicles can also be referred to as control units. Control units in vehicles, in particular motor vehicles, can have a computing unit, memory, interfaces, and possibly other components, which are required for processing input signals with input data in the control unit and for generating control signals with output data. The interfaces are used to receive the input signals or to output the control signals. Vehicle components in the vehicle can be actuated by means of the control signals.

Driving functions both for advanced driver assistance systems (ADAS) and also for autonomous or semi-autonomous driving can be realized using the control units and vehicle components.

One option for testing control units and/or vehicle components comprises testing the control units and/or vehicle components with the corresponding sensors in the installed state, for example, in a motor vehicle during test drives. This is time-consuming and cost-intensive, and many situations cannot be assessed in a real environment because they only occur in extreme cases, for example, in accidents. For this reason, such control units and/or vehicle components are tested in artificial environments, for example, in test benches.

### SUMMARY OF THE INVENTION

It is therefore an object of the invention to provide a test bench for testing at least one vehicle component. The test bench is set up to exert a translational load on the at least one vehicle component in the direction of a component axis, wherein the test bench has a plurality of drives which are set up to generate the load. A test bench control is provided which is designed to jointly regulate the drives in order to achieve the load on the vehicle component based on a central reference variable.

This enables a test bench that takes up little space.

The test bench can have a plurality of drives which are set up to generate the translational load for the vehicle component. In a method for generating the translational load in the direction of a component axis for the vehicle component in the test bench, the plurality of drives can be regulated jointly in order to achieve the load on the vehicle component based on the central reference variable.

Such a method for generating the load can be realized on a test bench that takes up little space.

It can be achieved by means of the test bench for the at least one vehicle component and the corresponding method that a plurality of drives can be used to generate the load on the vehicle component, wherein the majority of the drives can also be arranged in a particularly space-saving manner. By providing the test bench control for joint regulation of the drives in order to achieve the load on the vehicle component based on the central reference variable, the particular load to be generated by one of the drives can be specified in a defined manner. Regulation-related problems that could arise from the use of multiple drives can be avoided in this way. In addition, the test bench or the method can generate a realistic load on the vehicle component in the translational direction. Hence, the testing of at least one vehicle component can be carried out more realistically. A test bench that generates a load in the form of a torque for a rotary movement and exerts it on the vehicle component is also conceivable.

The test bench can have components for testing the function of at least one vehicle component under different conditions. For this purpose, the test bench can be set up to apply a translational, mechanical load to the vehicle component. In particular, the load comprises exerting a force in the direction of the component axis.

Further, the test bench can be set up to communicate electrically with the vehicle component, for example, to control it and to characterize changes due to the mechanical load using the electrical interfaces of the vehicle components. The communication between the test bench and the vehicle component can also take place, e.g., via at least one vehicle bus such as, e.g., CAN, LIN, FlexRay, etc., which emulates the corresponding vehicle bus or vehicle buses or those present in the real vehicle.

Different test scenarios for testing the vehicle component can also be provided with the test bench for the vehicle component. In particular, vehicle parameters can be made available for the vehicle component. For example, the vehicle components can be set to certain operating modes as part of the test on the test bench. Various information can also be transmitted to the vehicle component that the vehicle component under test would receive in the vehicle, e.g., from other vehicle components. An example of a transmitted vehicle parameter is the vehicle speed.

The different operating modes of the vehicle component can depend in particular on the at least one vehicle parameter. For example, a steering system can adopt a different operating mode depending on the vehicle speed and react differently to an operation and/or forces. The parameters and/or information can be transmitted, e.g., via a vehicle bus, e.g., CAN, LIN, MOST, FlexRay, etc. The test bench can have the same type of bus as would also be present in the real vehicle.

The simulation of the environment of the vehicle components can be done using the test scenarios. When running through the test scenarios, the vehicle component can be set to different operating modes. A simulated sensor can also be varied, for example, in its output signal. This variation can be applied to the vehicle component by the test bench and/or be evaluated in its effect on the vehicle component.

The at least one vehicle component can be a steering system, a braking system, or a vehicle damping system, for example. However, other vehicle components are also possible. Vehicle components absorb loads, in particular forces and/or torques, during vehicle operation and exert loads, in particular forces and/or torques.

The translational load of the at least one vehicle component is exerted in the direction of the component axis. The component axis is, for example, an axis in which the vehicle component is oriented. Furthermore, the translational load during operation of the vehicle component is to be expected primarily in the direction of the component axis, for example. The load exerted by the test bench therefore simulates the load on the vehicle component in real operation in the vehicle as realistically as possible.

In this regard, a plurality of drives can be provided that generate the load. In particular, the drives can be electric motors of any design. Linear motors are an example. A compact design of the test bench is possible due to the use of a plurality of drives, because a single drive can be smaller as a result.

Furthermore, the test bench control is provided which is designed to jointly regulate the drive. This avoids regulation-related problems that could occur if the drives were only regulated individually. The translational load of the vehicle component is therefore effected based on the central reference variable used by the test bench control to achieve joint regulation.

The component axis usually runs through the vehicle component on which the translational load is exerted. In the case of the translational load, a force is exerted by the drives in the direction of this axis. This load can then be measured by one or more sensors, wherein the sensor or sensors are arranged in such a way that they can detect the translational load directly or indirectly. The measured values of the sensor(s) can be fed back to the test bench control and thus used for regulating the translational load.

The central reference variable depends on the test scenario for testing the vehicle component. The drives are actuated as a function of this reference variable. The reference variable can be determined, e.g., in the test bench control. The reference variable can be determined, e.g., by the test bench control. It is possible, e.g., that a setpoint for the load is specified to the test bench control and it then determines therefrom the central reference variable by means of which the drives are regulated. The setpoint can be determined, e.g., from data stored in an internal or external memory. Measured values that occur during testing can also influence the reference variable.

A first drive of the plurality of drives can be designed and arranged in such a way that the first drive exerts the load in the direction of a first axis, wherein a second drive of the plurality of drives is designed and arranged in such a way that the second drive exerts the load in the direction of a second axis. A converter can be provided which converts the respective translational loads generated by the first and second drive in the respective first and second axes into the translational load in the direction of the component axis. By using the different axes for the two drives, which are different from the component axis and from each other, for example, a compact design of the test bench is then possible. The converter can have the role of converting the individual translational loads of the respective drives into the translational load in the direction of the component axis. For this purpose, a corresponding mechanism, e.g., can be provided which realizes this conversion. This mechanism then redirects the load and combines the two loads of the individual drives into a total load in the component axis.

The vehicle component can be operated by a control unit and the test bench control is set up to generate the reference variable for the joint actuation of the drives as a function of a control unit signal. In this case, the control unit signal can be sent by the control unit and received by the test bench control. In this case, the control unit, for example, the control unit for a steering system, then sends the control unit signal to the test bench control, for example, via a bus connection, for example, a CAN bus. This control unit is then either connected to the test bench in order to transmit the control unit signal to the test bench control, or the control unit is virtually simulated, e.g., by the test bench, and the control unit signal is then transmitted to the test bench control. The control unit signal indicates which actions the control unit has performed. A coordinated translational loading of the vehicle component can then take place.

The test bench control can be set up to distribute the value of the central reference variable proportionally to the drives as a function of the load, to be generated proportionally, on the drives. This means, for example, that the test bench control determines a reference variable as a function of the control unit signal in order to then determine the respective load to be generated by the drives in order to then be able to provide the total load for the vehicle component according to the value of the reference variable. The value of the reference variable is thereby divided accordingly between the two drives. This can result in simple regulation of the desired load because the reference variable is then divided proportionally between the two drives as a numerical value, for example. In so doing, the division is then made to the respective actuation unit of the individual drives, e.g., proportionally in equal amounts. In the case of two drives, the proportional division into equal amounts would then mean a one-half division, and in the case of three drives then accordingly into thirds. Other divisions into unequal amounts are also conceivable.

The load to be generated by the drives can be the same in amount in each case. The test bench control can then be set up to divide the value of the reference variable proportionally into equal parts. This proportional division is then divided in half for two drives, so that a simple division of the reference variable in terms of value is possible.

Furthermore, it is proposed that the test bench can have a measuring device which measures the translational load on the vehicle component with at least one sensor and outputs at least one measurement signal as a function of this measurement. For example, feedback to the generation of the reference variable or monitoring of the translational load is then possible by means of this measuring device. The regulation can then be realized thereby. In particular, the translational load can then be readjusted via the respective drives.

The measuring device can have at least one position sensor and/or at least one speed sensor and/or at least one force sensor and/or at least one acceleration sensor.

In particular, the measuring device can have a position sensor and a speed sensor. The measurement signal can then have a position signal and/or a speed signal.

In particular, the measuring device can have a force sensor and an acceleration sensor. The measurement signal can then have a force signal and/or an acceleration signal.

The distance traveled or angle covered by the movement of an object can be detected by a position sensor or displacement sensor or displacement transducer and converted into suitable signals for processing, transmission, and control. A wide variety of physical principles can be used for the realization of position sensors: Capacitive, inductive, optical, or magnetic sensors can be used. But other further technologies are also possible. Speed sensors measure the distance traveled or the angle covered per unit of time.

A force sensor, also known as a force transducer or load cell, can be used to measure the force acting on the sensor. In this regard, both tensile and compressive forces can be measured by elastic deformation. Again, different technologies can be used for force sensors. For example, the change in electrical resistance as a result of the application of force can be used for such a force sensor. An electrodynamic force sensor can also be used. A current through a coil located in a magnetic field is proportional to the force as when it compensates for the deflection, i.e., holds the coil in a fixed position. A piezo force sensor can also be used: In a piezoceramic, the application of force creates a charge distribution that is proportional to the force. Spring body force sensors can also be used. In this regard, the spring body of the sensor is elastically deformed as a result of the force applied. The deformation of the spring body can be converted into a change in electrical voltage using strain gauges whose electrical resistance changes with the strain. Capacitive sensors can also be used.

In the case of an acceleration sensor, the inertial force acting on a test mass is usually determined. Micromechanically manufactured sensors in particular are used for this purpose. These are referred to in particular as microelectromechanical systems (MEMS) and are usually made of silicon. These sensors are spring measuring systems in which the springs are silicon rods only a few micrometers wide and the mass is also made of silicon. Strain gauges can also be used as acceleration sensors. Other measuring principles are possible.

The test bench control can be set up to generate the central reference variable as a function of the at least one measurement signal. Regulation of the reference variable can be achieved thereby because the measurement signal is used to detect the load to which the previous reference signal has led.

The test bench control can be set up to determine the reference variable either as a function of the position signal and the speed signal or as a function of the force signal and the acceleration signal. Two modes can be used thereby: one is a position mode and the other a force mode. The two modes can be used alternately, for example. A change between the modes can be made, e.g., by an operator of the test bench or by the test scenario.

A respective drive can have at least one electric motor, in particular at least one linear motor. The linear motor can also be an electric motor that effects a translational movement.

Moreover, it is possible that a respective actuation unit can be provided, which is designed to control the respective drive. In this regard, this specific actuation unit can then keep the respective drive in certain characteristic maps, for example, wherein the load to be exerted by the respective drive is then defined via the superposition or linking by the reference variable.

It can be provided that the respective actuation unit for the respective drive can have a respective power converter which is electrically connected to the respective drive for actuation.

The test bench control can be set up to transmit the respective proportional value of the reference variable to the respective actuation unit, wherein the respective actuation unit is set up to control the respective drive as a function of the proportional value of the reference variable.

Furthermore, it is proposed that the test bench control can have at least one processor and at least one FPGA. The processor can be a microprocessor or a plurality of microprocessors or a combination with signal processors or only one signal processor or other combinations of processor types, whereas the FPGA is a so-called Field Programmable Gate Array, which is an integrated circuit into which a logic circuit can be loaded. An accordingly desired circuit structure is then created. This is formulated by means of a hardware description language and translated by a generator software into a configuration file, which specifies how the physical elements in the FPGA are to be connected.

The test bench can have a steering test bench which is set up to exert a translational load on the at least one vehicle component, wherein the vehicle component is designed as a vehicle steering system.

Furthermore, it is possible for the test bench to have a damper test bench which is set up to exert a translational load on the at least one vehicle component, wherein the vehicle component is designed as a vehicle damper.

Moreover, it is possible for the test bench to have a brake test bench which is set up to exert a translational load on the at least one vehicle component, wherein the vehicle component is designed as part of the vehicle brake system.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of a test bench;

FIG. 2 shows a second schematic illustration of the test bench with test bench components;

FIG. 3 shows a third schematic illustration of the test bench control with a regulation in the position mode; and

FIG. 4 shows a fourth schematic illustration of the test bench control with a regulation in the force mode.

### DETAILED DESCRIPTION

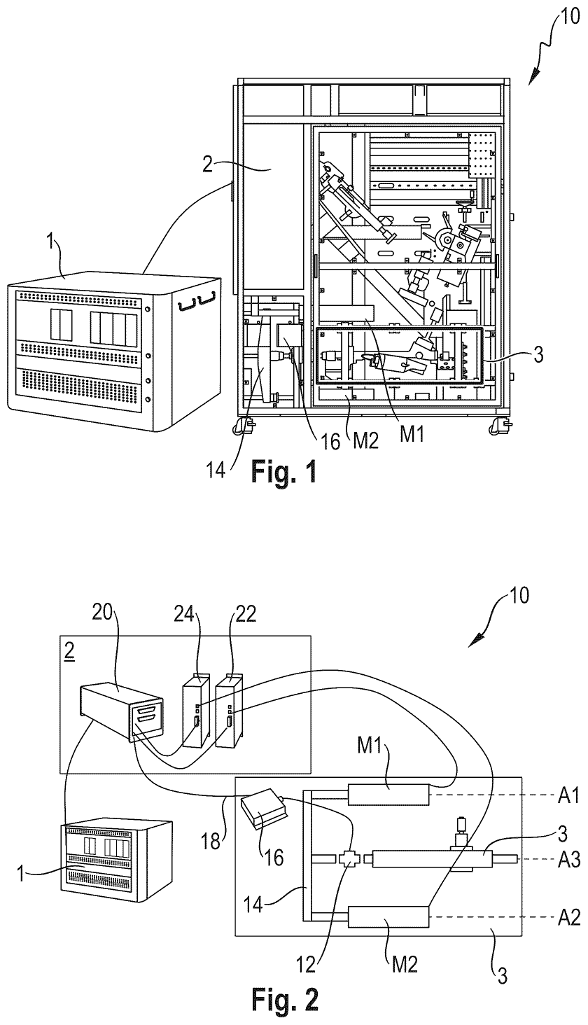

FIG. 1 shows a first schematic illustration of a test bench 10. A test bench control 1 and a separate structure with an area for actuation units 2 and an area 3 for a vehicle component are shown. The test bench has further components, such as, e.g., for the simulation of a driver's operating procedures. Other components that may be necessary for the operation of test bench 10 have been omitted for the sake of simplicity.

Test bench control 1 is shown as a separate unit in FIG. 1. Optionally, it can also be arranged in the same structure as actuation units 2. The test bench control 1 and actuation units 2 are connected to each other wired or wirelessly.

Vehicle component 3, which in the present case is designed as a gearbox for a steering system, can be tested by means of test bench 10. For the test, the gearbox is subjected to a translational load. This is intended to simulate, for example, the forces acting on the vehicle components during driving.

Vehicle component 3 is actuated by drives M1, M2, which, e.g., have a respective power converter. Power converters convert a first current into a second current, for example, from alternating current to direct current or vice versa. Furthermore, power converters are suitable for changing characteristic parameters of the current.

These power converters are regulated by test bench control 1 with a central reference variable FG in order to carry out the corresponding checks and tests on vehicle component 3. In the present case, it is provided that two drives M1, M2 generate the load for vehicle component 3.

In this regard, a converter 14 is provided, which combines the loads of the individual drives M1, M2 into a single translational load for vehicle component 3. This enables a particularly compact design of test bench 10. In particular, a so-called double spindle drive system can be used, which has axes A1, A2 (FIG. 2), in which the two drives M1, M2 are disposed, offset parallel to a component axis A3. Forces from axes A1, A2 of the drives are converted into forces in component axis A3 by converter 14. In the example shown, component axle A3 corresponds to an axle of the steering gear.

Converter 14, which combines the two loads of the two drives M1, M2 into one load, can, for example, have a bar. In this case, purely mechanical constructions but also pneumatic or hydraulic solutions can be used for implementation.

A sensor interface 16, which can read out and forward measured values determined by one or more sensors 12, 12.1, 12.2, 12.3, is also disposed in the area of the converter (FIGS. 2, 3, and 4).

FIG. 2 shows a second schematic illustration of test bench 10 with test bench control 1, the area for actuation units 2, and vehicle component 3. Vehicle component 3 (e.g., brake, damper or steering system, and/or the corresponding gears) is provided between the two drives M1 and M2 on component axis A3, whereas first drive M1 is aligned on first axis A1 and second drive M2 on second axis A2. A translational load, which drives M1 and M2 each generate, is generated in the direction of the axes A1 and A2 by the respective drive M1 and M2, whereas the summed load occurs in the direction of component axis A3. The direction or sign of the loads can also be offset by 180° to each other. First axis A1, second axis A2, and component axis A3 can be formed parallel but are preferably not identical.

The two drives M1 and M2 are connected to each other via a converter 14 with their output from which the load is output. With linear motors, for example, the load is output as a translational load. Converter 14 then converts the respective translational loads of drives M1 and M2 into a combined added translational load on vehicle component 3.

This total load generated by converter 14 is exerted on vehicle component 3. A sensor 12 is provided. The translational load exerted on vehicle component 3 can be determined by measurement via sensor 12. A sensor interface 16 is provided for this purpose, which is preferably electrically connected to sensor 12 and transmits the sensor values as a measurement signal 18 to a control interface 20 in the area for actuation units 2. This transmission of measurement signal 18 is usually wired but it can also be transmitted wirelessly.

Control interface 20 is connected to test bench control 1. The connection of control interface 20 to test bench control 1 can occur, e.g., via a wired (e.g., copper or optical) or wireless transmission. An example of a wired transmission is the IOCNet cable. Control interface 20 is also connected to actuation units 22 and 24 for drives M1 and M2. These actuation units 22 and 24 are designed as power converters in the example shown. The connection of control interface 20 to actuation units 22 and 24 can occur, e.g., via wired (e.g., copper or optical) or wireless transmission. An example of a wired transmission is the TWINSync cable.

Test bench control 1 generates the central reference variable FG as a function of a setpoint SW and measurement signal 18. The setpoint SW can also comprise a plurality of setpoints SW. The setpoint SW can be transmitted to test bench control 1 by means of predetermined test programs or predetermined test scenarios. Test bench control 1 transmits the reference variable FG to control interface 20, which transmits the reference variable FG proportionally to actuation units 22 and 24. Actuation units 22 and 24 control drives M1 and M2 depending on the reference variable FG. In particular, it can be provided that drives M1 and M2 are regulated in relation to the proportional reference variable FG. The regulation algorithm acts on the reference variable FG, which is then split between actuation units 22, 24.

The distribution of the reference variable FG to actuation units 22, 24 can be carried out by the test bench control. Alternatively, the reference variable FG can be distributed to actuation units 22, 24 by control interface 20.

Test bench control 1 can generate the reference variable FG for testing vehicle component 3 based on vehicles and/or driving situations simulated in real time and regulate drives M1, M2 via actuation units 22, 24 to exert the load. The regulation is therefore based on the vehicles and/or driving situations simulated in real time. Control interface 20 can achieve a modification of the reference variable FG depending on measurement signal 18. This achieves a feedback to actuation units 22 and 24, which can readjust the regulation of drives M1 and M2 if the resulting translational load does not correspond to the specification by the reference variable FG. Alternatively, it is possible that control interface 20 forwards measurement signal 18 to test bench control 1 and consequently test bench control 1 itself modifies the reference variable FG depending on measurement signal 18 and thus realizes the regulation.

This provides a regulation that prevents drives M1 and M2 from influencing each other. A combination of a respective individual drive regulation with superimposed regulation by the reference variable FG is therefore provided.

The main components for the example shown for the area of actuation units 2 are a so-called TWINSync solution and drives 22 and 24, which are designed as power converters. The TWINSync solution based on FPGA technology forms control interface 20 between test bench control 1 and power converters 22 and 24. Power converters 22 and 24 realize the individual motor regulation of spindle motors M1 and M2. Sensor interface 16 to sensor 12, whose measurement signal 18 is in turn evaluated partly based on FPGA, is also connected to control interface 20, in particular via the TWINSync solution.

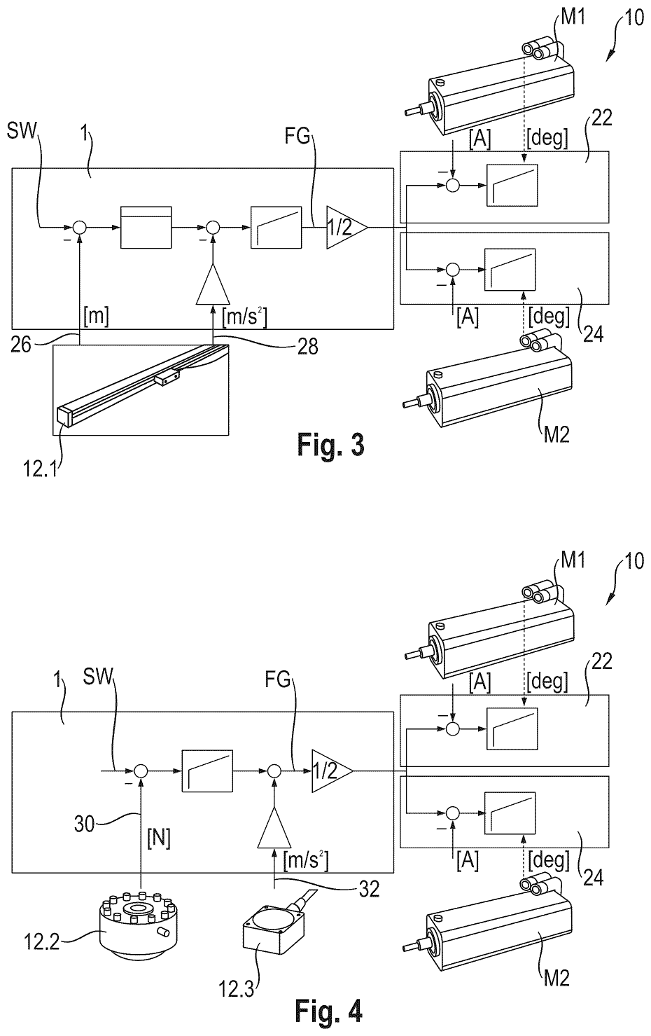

FIG. 3 shows a third schematic illustration of test bench 10.

A regulation structure implemented in test bench control 1 is shown. A load to be applied to the vehicle component is provided to the regulation structure as the setpoint SW. The setpoint SW of the load can result, e.g., from the test scenario and depend on a setpoint SW calculated by a real-time simulation.

Regulation of the load and a corresponding generation of the reference variable FG as a function of the position and speed are provided in test bench control 1.

The setpoint SW is linked to a position value in the regulation structure of test bench control 1. The position value is linked via a position signal 26, which was determined by a position sensor 12.1. The result of this link, e.g., a subtraction, is fed into a position controller, which can be designed as a P controller, whose output signal is again linked to a speed signal 28 via a link, e.g., a subtraction. The output signal of this second link is fed into a speed controller, which can be designed as a PI controller or PI regulator. The speed controller outputs the reference variable FG. The reference variable FG is then divided proportionally, halved in the example shown, and provided to the individual regulation units 22 and 24 for drives M1 and M2 via control interface 20. For reasons of clarity, control interface 20 is not shown in FIG. 3. In this regard, these values, which correspond to the respective half reference variable FG, are linked to a respective working current of the respective motor M1 or M2 via a subtraction. The regulation of drives M1 and M2 then occurs via the corresponding characteristic curve of the individual controllers 22 and 24 of the two drives M1 and M2. The regulation of the two drives M1 and M2 is realized via a respective actuation unit 22 and 24. Actuation units 22, 24 are designed as power converters in the example shown.

The position signal 26 and the speed signal 28 are each provided by a position sensor 12.1. Position sensor 12.1 can be designed as a magnetic linear sensor, as an optical sensor, e.g., laser, or as an inductive sensor. Sensor 12 has position sensor 12.1.

The individual drives M1 and M2, for example, spindle motors, are operated by field-oriented regulation. The field can be formed, e.g., by a permanent magnet. The field-oriented regulation can be designed such that it impresses a current in exactly the axis of the electric motor, so that an ideal utilization of the permanent field for torque generation is generated.

Alternatively, the field-oriented regulation can be designed such that the electromagnetic field is weakened in order to increase the respective speed of the respective linear motor M1 or M2. In examples, the field can also be strengthened in order to reduce the respective speed of the respective motor M1 and M2.

FIG. 4 shows a fourth schematic illustration of test bench 10.

A control loop implemented in test bench control 1 is shown. A load to be applied to the vehicle component is provided to the control loop as the setpoint SW. The setpoint SW of the load can result, e.g., from the test scenario and depend on a setpoint SW calculated by a real-time simulation.

Regulation of the load and a corresponding generation of the reference variable FG as a function of the force and acceleration is provided in test bench control 1. The force is detected by a force sensor 12.2 and output via a force signal 30. The acceleration is detected by an acceleration sensor 12.3 and output via an acceleration signal 32. Sensor 12 has force sensor 12.2 and acceleration sensor 12.3.

In the control loop, the setpoint SW for the force is linked to force signal 30 of force sensor 12.2 via a subtraction. The linkage value is fed to a force regulation, which can be designed as a PI regulation. Other controllers are also conceivable here, such as, for example, state space regulation or a neural network. The corresponding output value of the force regulation via the indicated characteristic curve is fed to a further link with an acceleration signal 32 of an acceleration sensor 12.3, which outputs acceleration signal 32. Acceleration signal 32 is fed to the second link via an amplifier. The value determined in this way from this second link is the reference variable FG, which in turn is divided proportionally between drives M1, M2. In this example, the value is halved. This halved value passes via control interface 20 to the individual actuation units 22 and 24, which are designed as power converters as in the example in FIG. 2. For reasons of clarity, control interface 20 is not shown in FIG. 4.

This halved value is again linked to a current value of drives M1 and M2 via a subtraction and is then fed to a current controller, which then outputs the current or the current regulation value for drives M1 and M2 respectively.

Alternative regulations for test bench 10 are shown in FIG. 3 and FIG. 4. Test bench 10 can be designed such that, e.g., an operator of test bench 10 can switch manually or automatically via the test scenario between a regulation according to FIG. 3 and a regulation according to FIG. 4. In particular, it can be provided that sensor 12 then has position sensor 12.1, force sensor 12.2, and acceleration sensor 12.3.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A test bench for at least one vehicle component, the test bench being set up to exert a translational load on the at least one vehicle component in a direction of a component axis, the test bench comprising:
at least two drives that are set up to generate the load; and
a test bench control to jointly regulate the drives in order to achieve the load on the vehicle component based on a reference variable.

2. The test bench according to claim 1, wherein a first drive of the at least two drives is designed and arranged such that it exerts the load in a direction of a first axis, wherein a second drive of the at least two drives is designed and arranged such that it exerts the load in a direction of a second axis, wherein a converter is provided which converts the respective translational loads generated by the first and second drive into a translational load in a direction of the component axis.

3. The test bench according to claim 1, wherein the vehicle component is operated by a control unit, and wherein the test bench control is set up to generate a reference variable for a joint actuation of the at least two drives as a function of a control unit signal, and wherein the control unit signal is received by the test bench control.

4. The test bench according to claim 1, wherein the test bench control is set up to distribute the value of the reference variable proportionally to the drives as a function of the load, to be generated proportionally, on the at least two drives.

5. The test bench according to claim 4, wherein the load to be generated by the drives is the same in amount, and wherein the test bench control is set up to divide the value of the reference variable proportionally.

6. The test bench according to claim 1, wherein the test bench has a measuring device which measures the translational load on the vehicle component with at least one sensor and outputs at least one measurement signal as a function of this measurement.

7. The test bench according to claim 6, wherein the measuring device further comprises at least one position sensor and/or at least one speed sensor and/or a force sensor and/or an acceleration sensor.

8. The test bench according to claim 6, wherein the test bench control is set up to generate the reference variable as a function of the at least one measurement signal.

9. The test bench according to claim 6, wherein the measurement signal has a position signal and a speed signal.

10. The test bench according to claim 6, wherein the measurement signal has a force signal and an acceleration signal.

11. The test bench according to claim 9, wherein the test bench control is set up to determine the reference variable either as a function of the position signal and the speed signal or as a function of the force signal and the acceleration signal.

12. The test bench according to claim 1, wherein a respective drive has at least one electric motor, or at least one linear motor.

13. The test bench according to claim 1, further comprising a respective actuation unit, which is designed to actuate a respective drive of the at least two drives.

14. The test bench according to claim 13, wherein the respective actuation unit for the respective drive has a respective power converter that is electrically connected to the respective drive for actuation.

15. The test bench according to claim 13, wherein the test bench control is set up to transmit the respective proportional value of the reference variable to the respective actuation unit, wherein the respective actuation unit is set up to control the respective drive as a function of the proportional value of the reference variable.

16. The test bench according to claim 1, wherein the test bench control has at least one processor and at least one FPGA.

17. The test bench according to claim 1, further comprising a steering test bench which is set up to exert a translational load on the at least one vehicle component, wherein the vehicle component is designed as a vehicle steering system.

18. The test bench according to claim 1, further comprising a damper test bench which is set up to exert a translational load on the at least one vehicle component, wherein the vehicle component is a vehicle damper.

19. The test bench according to claim 1, further comprising a brake test bench that is set up to exert a translational load on the at least one vehicle component, wherein the vehicle component is part of a vehicle braking system.

20. A method for generating a translational load in a direction of a component axis for a vehicle component in a test bench, the method comprising:
providing the test bench with at least two drives;
generating the load via the at least two drives; and
jointly regulating the at least two drives in order to achieve a load on the vehicle component based on a reference variable.
